(19) United States
(12) Patent Application Publication
(10) Pub. No.: US 2010/0013130 A1
(43) Pub. Date: Jan. 21, 2010

(54) Molding Method For Thin Parts

(75) Inventors: Ernesto Ramirez, Austin, TX (US); Kevin Mundt, Austin, TX (US)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/175,488

(22) Filed: Jul. 18, 2008

(51) Int. Cl. B29C 43/00

(52) U.S. Cl. 264/544; 425/405.1

(57) ABSTRACT

A method for molding a part includes introducing a gas into a material that is in a liquid phase. A mold is then positioned in an intermediate position The material, in the liquid phase and including the introduced gas, is then injected into the mold. The mold is then positioned in a closed position such that the material that was injected into the mold is compressed by the mold.

### BACKGROUND

The present disclosure relates generally to information handling systems, and more particularly to molding thin parts for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

As mobile computing becomes more and more popular, the desire for IHSs to be both small in size and light in weight grows. In order to achieve this, heavier parts in the IHS chassis may be replaced with plastic parts and, in order to further reduce size and weight, it may be desirable to manufacture those plastic parts as thin as is structurally feasible. However, the manufacture of such thin plastic parts raises a number of issues.

Plastic parts of an IHS chassis are typically manufactured using a molding process such as, for example, an injection molding process. Such process typically involves injecting a molten plastic resin into a mold under high pressure in order to force the molten plastic resin to flow throughout a mold volume such that it fills the mold volume and then cools to form the desired part. However, as the structure of the part becomes thinner, the resultant thin mold volume can create a resistance to the flow of the molten plastic resin that can prevent the molten plastic resin from flowing to all parts of the mold volume before the material cools, which can result in a malformed part. The solution to such problems is to provide the part smaller or thicker such that the molten plastic resin may fill the mold volume before cooling. However, this puts a limit on the size and/or thinness of a part that may be provided and then molded using such molding processes.

Accordingly, it would be desirable to provide for molding a thin part absent the issues discussed above.

### SUMMARY

According to one embodiment, a method for molding a part includes introducing a gas into a material that is in a liquid phase, positioning a mold in an intermediate position, injecting the material, in the liquid phase and including the introduced gas, into the mold, and positioning the mold in a closed position such that the material that was injecting into the mold is compressed by the mold.

### BRIEF DESCRIPTION OF THE DRAWINGS

FIG. 1a is a schematic view illustrating an embodiment of an IHS.

FIG. 1b is an exploded perspective view illustrating an embodiment of the IHS of FIG. 1a.

FIG. 2a is a schematic view illustrating an embodiment of a molding system in an open position.

FIG. 2b is a schematic view illustrating an embodiment of a material supply system used in the molding system of FIG. 2a.

FIG. 3a is a flow chart illustrating an embodiment of a method for molding a part.

FIG. 3b is a schematic view illustrating an embodiment of the molding system of FIG. 2a in an intermediate position.

FIG. 3c is a schematic view illustrating an embodiment of the molding system of FIG. 2a in the intermediate position with a material being injected into a first mold volume defined by the mold.

FIG. 3d is a schematic view illustrating an embodiment of the molding system of FIG. 2a in the intermediate position with a material located in a first mold volume defined by the mold.

FIG. 3c is a schematic view illustrating an embodiment of the molding system of FIG. 2a in a closed position that has compressed the material in the first mold volume defined by the mold to a second mold volume define by the mold to create a part.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

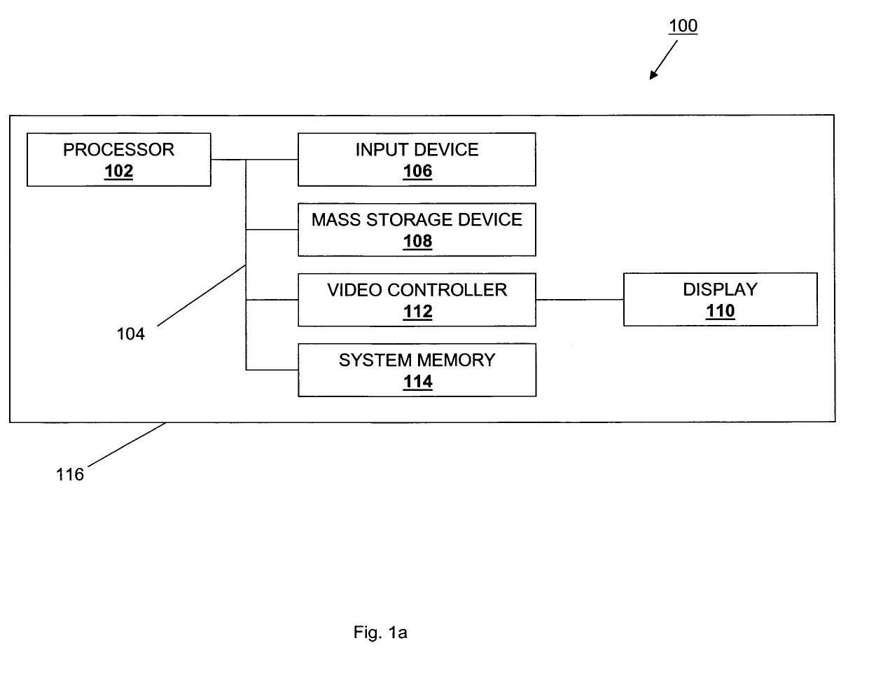

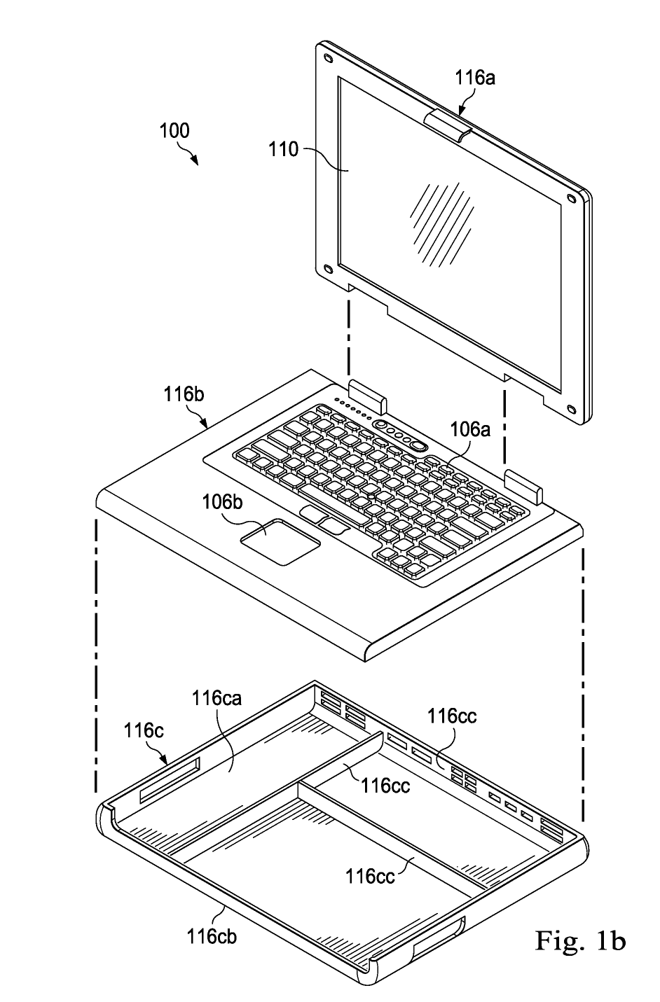

In one embodiment, IHS 100, FIG. 1a, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

Referring now to FIGS. 1a and 1b, an embodiment of the IHS 100 is illustrated. The IHS 100 includes the display 110 mounted in a display chassis 116a that is part of the chassis 116. The input device 106 includes a keyboard 106a and a touchpad 106b located on a chassis upper section 116b of the chassis 116. A chassis lower section 116c defines a component housing 116ca that may house components of the IHS 100 including, for example, the processor 102, the storage 108, the video controller 112, the system memory 114, and/or a variety of other IHS components known in the art. The chassis lower section 116c also includes a wall section 116cb and plurality of ribs 116cc that extend from the wall section 116cb and allow the chassis lower section 116c to be coupled to the chassis upper section 116b. In conventional IHSs, components that make up the surfaces of the chassis 116 may be fabricated out of a magnesium or other metallic materials, which can require substantial post-processing to create an aesthetically pleasing surface smoothness. Such post-processing raises manufacture times and costs for the IHS 100. Replacing the material used for the surfaces on the chassis 116 with a material that may be fabricated with a relatively smooth surface with little or no post-processing would reduce those manufacture times and cost. As it is desirable to make the IHS 100 as light and as thin as possible, a system and method was developed for producing the components that make up the surface of the chassis 116 out of materials that, in conventional processes, suffer from problems such as those described in the Background of the present disclosure. However, the present disclosure is not so limited, and one of skill in the art will recognize the variety of parts that may be fabricated using the system and method described below.

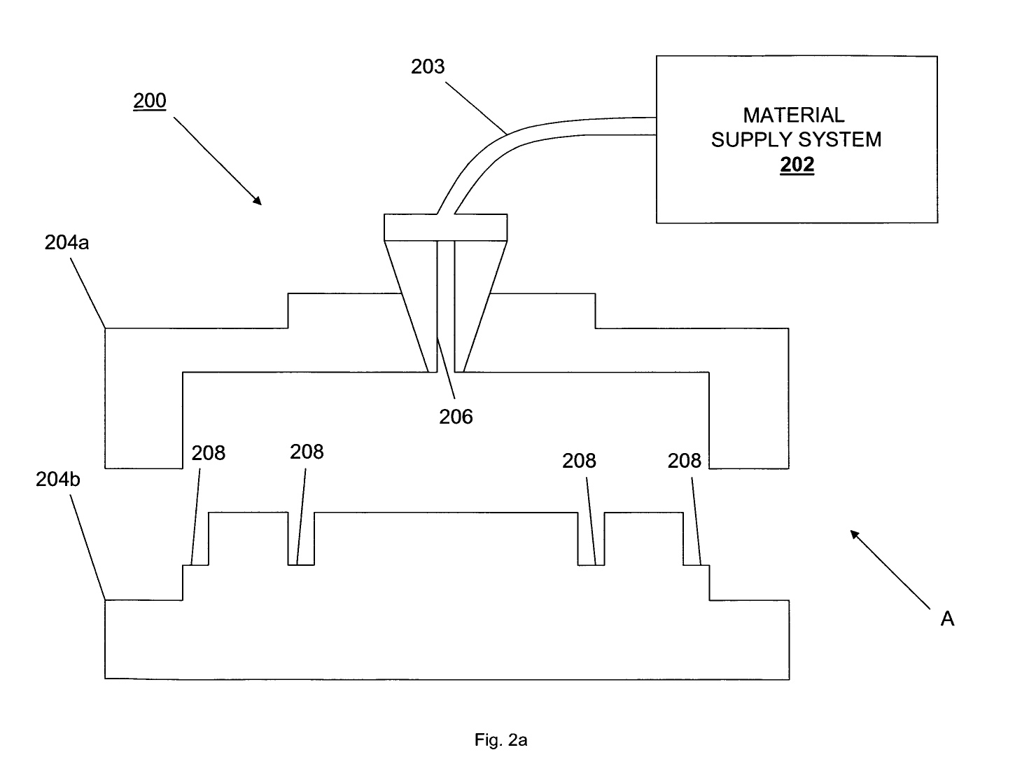

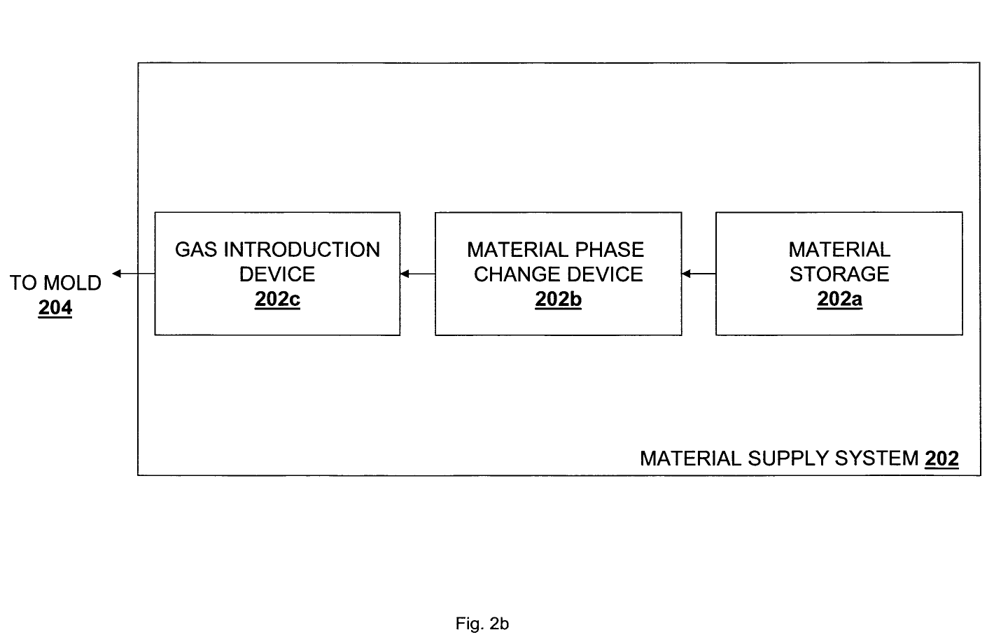

Referring now to FIGS. 2a and 2b, a molding system 200 is illustrated. The molding system 200 includes a material supply system 202 that is operable to supply the material that is being molded to produce a part. In an embodiment, the material supply system 202 includes a material storage 202a that may, for example, store the material in a solid phase. The material storage 202a is coupled to a material phase change device 202b that may, for example, convert the material to a liquid phase by, for example, heating the material. The material phase change device 202b is coupled to a gas introduction device 202c that may, for example, introduce a gas into the material in the liquid phase that is received from the material phase change device 202b, as described in further detail below. A coupling 203 couples the gas introduction device 202c to a mold 204 that includes a first section 204a and a second section 204b that are moveable relative to each other. A material injection member 206 is located on the first section 204a of the mold 204 and coupled to the coupling 203 in order to provide material from the material supply system 202 to a volume defined between the first section 204a and the second section 204b of the mold 204, as is described in further detail below. The second section 204b of the mold 204 defines a plurality of rib sections 208 that are to be a portion of the part being molded, as described in further detail below. As illustrated in FIG. 2a, the first section 204a and the second section 204b are oriented such that the mold 204 is in an open position A.

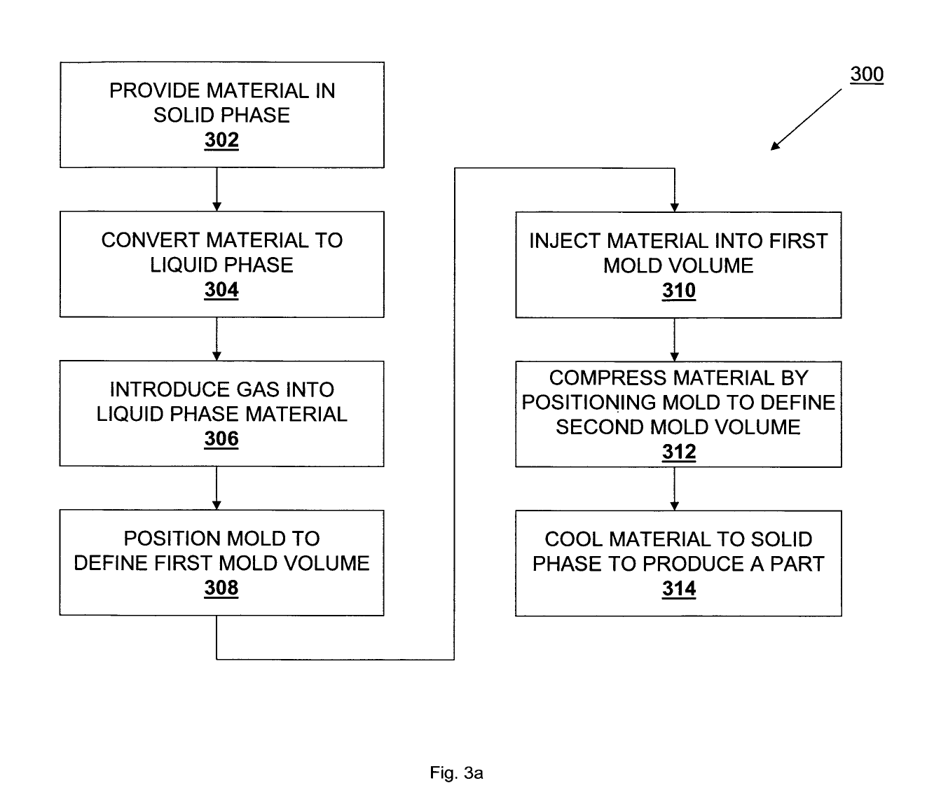

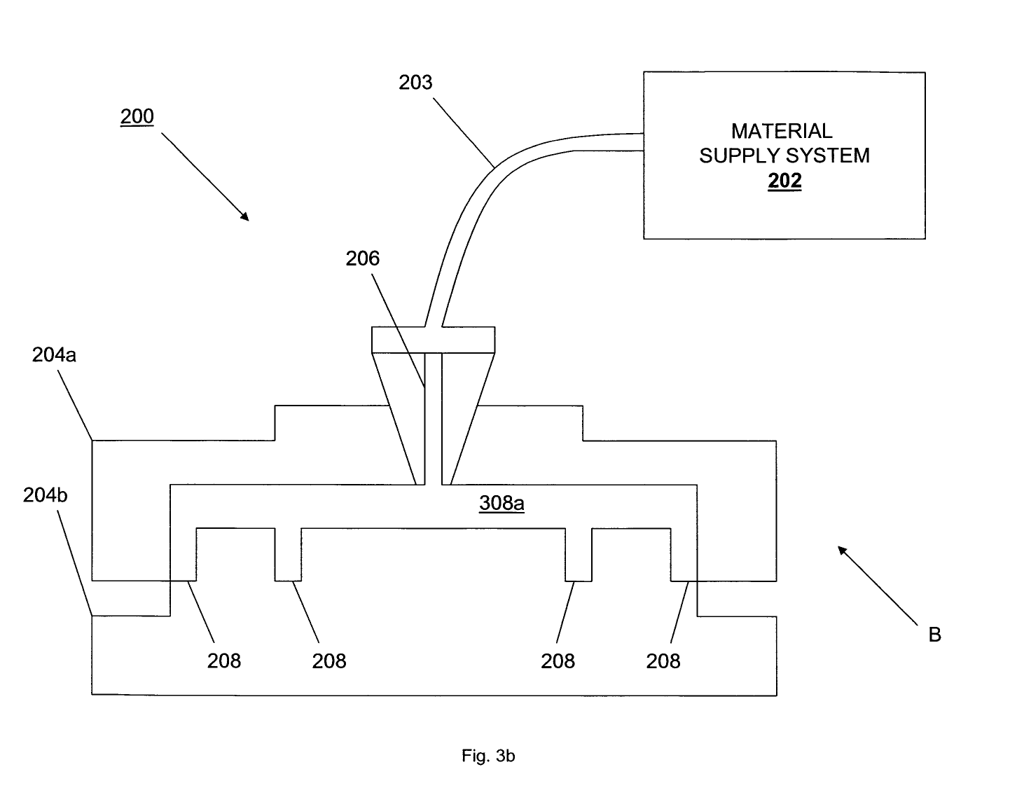

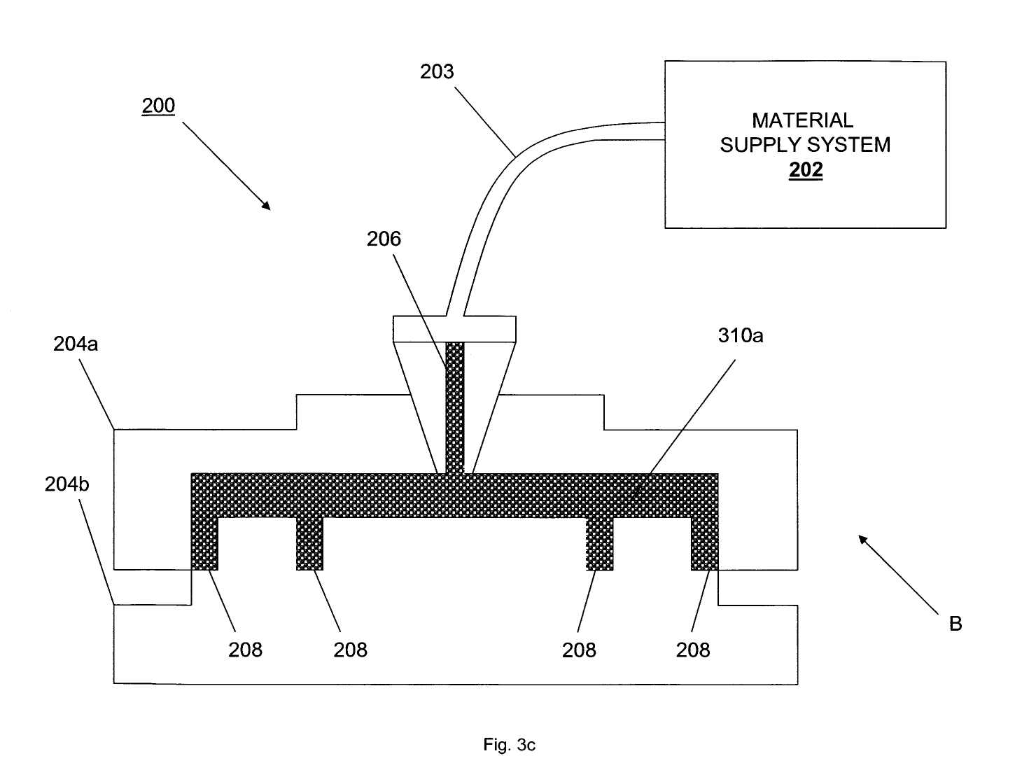

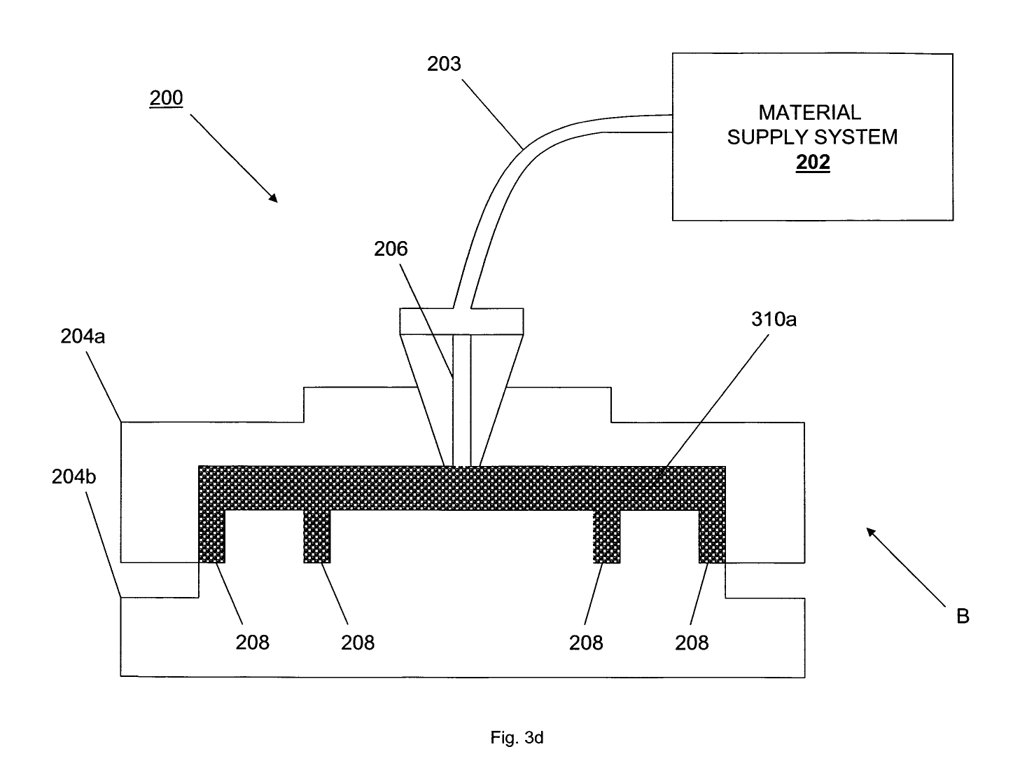

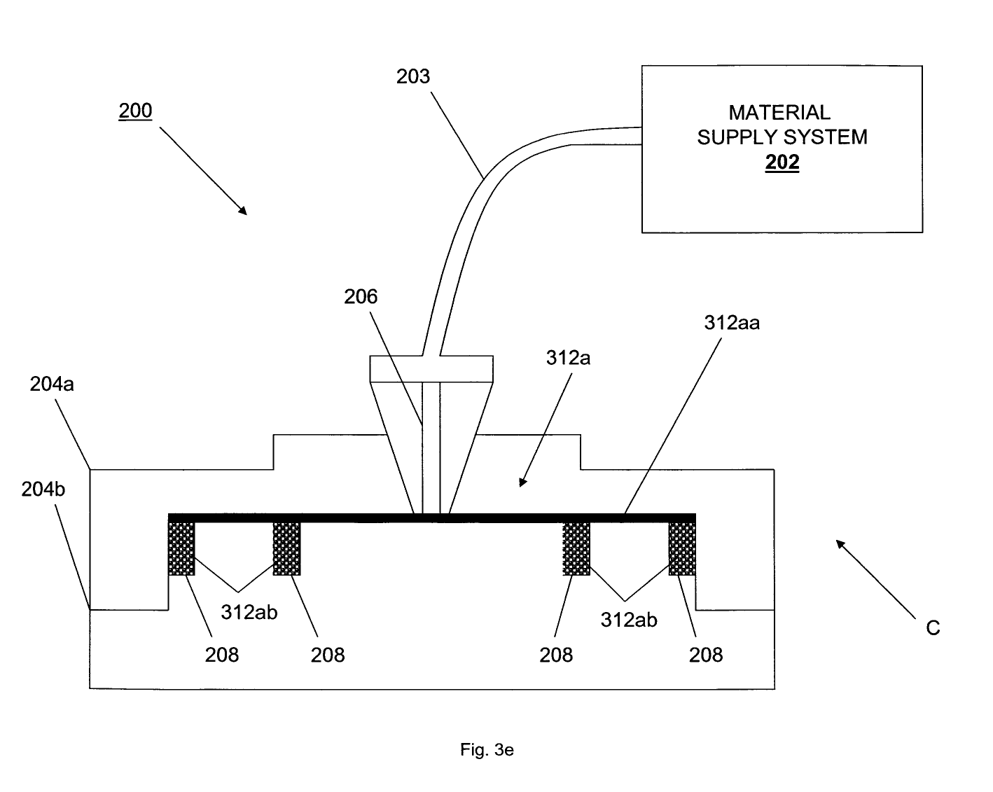

Referring now to FIG. 3a, a method 300 for molding a part is illustrated. The method 300 begins at block 302 where a solid phase material is provided. In an embodiment, a material in a solid phase is stored in the material storage 202a for use in the molding system 200. In an embodiment, the material is a plastic resin, and the material in the solid phase may include plastic resin pellets. The method 300 then proceeds to block 304 where the material is converted to a liquid phase. The material phase change device 202b accepts the material in the solid phase from the material storage 202a and is operable to convert the material from that solid phase to the liquid phase. In an embodiment, the material phase change device 202b may heat plastic resin pellets received from the material storage 202a to produce a molten plastic resin. The method 200 then proceeds to block 306 where gas is introduced into the liquid phase material. The material in the liquid phase is provided by the material phase change device 202b to the gas introduction device 202c, and the gas introduction device 202c introduces a gas into the liquid phase material. In an embodiment, the gas introduction device 202c may introduce an inert gas such as, for example, nitrogen or other inert gases known in the art, into the molten plastic resin such that a plurality of gas bubbles exist throughout the molten plastic resin.

Referring now to FIGS. 3a, 3b, 3c and 3d, the method 300 proceeds to block 308 where the mold 204 is positioned to define a first mold volume. The first section 204a and the second section 204b are moved relative to each other such that the mold 204 moves from the open position A, illustrated in FIG. 2a, to an intermediate position B, illustrated in FIG. 3b. With the mold 204 in the intermediate position B, a first mold volume 308a is defined between the first section 204a and the second section 204b of the mold 204. The method 300 then proceeds to block 310 where the material, in the liquid phase and including the gas introduced in block 306 of the method 300, is injected into the first mold volume 308a. The material 310a, in the liquid phase and including the gas, is provided by the material supply system 202 through the coupling 203 and the material injection member 206 to the first mold volume 308a, as illustrated in FIGS. 3c and 3d. In an embodiment, the gas bubbles in the liquid phase material that flow across the surface of the mold 204 are destroyed, but the gas bubbles within the liquid phase material are maintained. In an embodiment, the first mold volume 308a defined by the mold 204 in the intermediate position B is sufficient to allow the liquid phase material 310a to flow throughout the first mold volume 308a and fill the first mold volume 308a before any cooling of the material 310a impedes the flow of the material 308a. In an embodiment, the first mold volume 308a may be entirely filled with the material 310a (referred to as a “full shot” of material) in block 310 of the method 300.

Referring now to FIGS. 3a and 3e, the method 300 proceeds to block 312 where the material 310a, in the liquid phase and including the introduced gas, is compressed by positioning the mold 204 to define a second mold volume. The first section 204a and the second section 204b are moved relative to each other such that the mold 204 moves from the intermediate position B, illustrated in FIGS. 3b, 3c and 3d, to a closed position C, illustrated in FIG. 3e. With the mold 204 in the closed position C, a second mold volume 312a is defined between the first section 204a and the second section 204b of the mold 204. Due to the gas bubbles located throughout the material 310a, moving the mold 204 from the intermediate position B to the closed position C allows the material 310a to be compressed from the first mold volume 310a to the second mold volume 312a. In an embodiment, the second mold volume 312a comprises a thin-wall section 312aa and a plurality of rib sections 312ab located adjacent the rib sections 208 defined by the second section 204b of the mold 204. In an embodiment, the compression of the material 310a from the first mold volume 310a to the second mold volume 312a removes gas bubbles from the material that is located in the thin-wall section 312aa and allows gas bubbles to remain in the material located in the plurality of rib sections 312ab, as illustrated in FIG. 3e. The method 300 then proceeds to block 314 where the material 310a is cooled to a solid phase to produce a part. The material 310a in the second mold volume 312a may be allowed to cool from the liquid phase in which in was injected into the mold 204 to a solid phase over time, or a cooling process known in the art may be used on the mold 204 and the material 310a to decrease the cooling time, in order to produce a thin-walled part with a plurality of ribs. In an embodiment, the part produced may include a first thin-walled section 312aa made up of the material 310a in a homogenous solid phase (i.e., without gas bubbles) and a plurality of second rib sections 312ab made up of the material 310a in the solid phase that includes a plurality of gas bubbles throughout, as illustrated in FIG. 3e. In an embodiment, due to the rib sections 312ab being made up of the material 310a in the solid phase and including a plurality of gas bubbles throughout, and the thin-walled section 312aa being made up of the material 310a in a homogenous solid phase (i.e., without gas bubbles), the rib sections 312ab are less dense than the thin-walled section 312aa and therefore weigh less than the thin-walled section 312a per unit volume. In an embodiment, the thin-walled section 312aa and the plurality of rib sections 312ab have comparable shrink rates such that no “sink marks” (e.g., concave areas on the surface of the part opposite the rib section that would ideally be smooth) form. In conventional systems, a mold may be put in an intermediate position (similar to the intermediate position B, described above) and partially filled (referred to as a “short shot” of material) with a conventional material in a liquid phase. The intermediate position reduces the resistance to material flow that would exist with the mold in a closed position. In theory, upon moving the mold to the closed position, the conventional material displaces throughout the mold volume. However, in reality, the conventional material does not flow to the corners of large, thin parts and, because the conventional material in its liquid state is not compressible, the conventional material will be “squeezed” out around the parting lines of the mold, both of which result in a part molding failure. Thus, a system and method are provided that allow parts to be molded that are larger and thinner than conventional systems allow while avoiding many of the problems that those conventional systems produce.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A molding system, comprising:
a material supply system that comprises a gas introduction device, wherein the material supply system further comprises components that are operable to supply a material in a liquid phase to the gas introduction device, and the gas introduction device is operable to introduce a gas into the material in the liquid phase; and
a mold coupled to the material supply system, wherein in the mold is operable to receive the material, in the liquid phase and including the introduced gas, into a first mold volume that is defined by the mold, and the mold is further operable to compress the material located in the first mold volume into a second mold volume that is defined by the mold such that at least some of the introduced gas in the material is removed from the material.

2. The system of claim 1, wherein the material supply system comprises a material phase change device that is operable to convert the material to the liquid phase.

3. The system of claim 2, wherein the material supply system comprises a material storage that is coupled to the material phase change device, and wherein the material storage is operable to provide the material in a solid phase to the material phase change device.

4. The system of claim 1, wherein the first mold volume is defined by the mold in a intermediate position, and the second mold volume is defined by the mold in a closed position.

5. The system of claim 1, wherein the gas comprises an inert gas.

6. The system of claim 1, wherein the material comprises a plastic resin.

7. The system of claim 1, wherein the second mold volume comprises a thin-wall section and at least one rib section.

8. A method for molding a part, comprising:
introducing a gas into a material that is in a liquid phase;
positioning a mold in an intermediate position;
injecting the material, in the liquid phase and including the introduced gas, into the mold; and
positioning the mold in a closed position such that the material that was injecting into the mold is compressed by the mold and at least some of the introduced gas in the material is removed from the material.

9. The method of claim 8, wherein the gas comprises an inert gas.

10. The method of claim 8, wherein the material comprises a plastic resin.

11. The method of claim 8, wherein the mold defines a mold volume in the closed position that comprises a thin-wall section and at least one rib.

12. The method of claim 8, further comprising:
providing the material in a solid phase.

13. The method of claim 12, further comprising:
converting the material to the liquid phase.

14. The method of claim 8, further comprising:
cooling the liquid phase material in the mold while the mold is in the closed position in order to convert the liquid phase material to a solid phase material and produce a part.

15. The method of claim 14, wherein the part comprises a first section of the material in a homogenous solid phase and a second section of the material in a solid phase that includes a plurality of gas bubbles throughout the second section.

16. A method for molding a part, comprising:
providing a mold that comprises a first section and a second section, wherein the first section is moveable relative to the second section;
moving the first section relative to second section to define a first mold volume between the first section and the second section;
injecting a liquid phase material that comprises a plurality of gas bubbles into the first mold volume; and
compressing the liquid phase material that comprises the plurality of gas bubbles by moving first section relative to the second section to define a second mold volume that is smaller that the first mold volume and that comprises a thin-wall section and a rib section, wherein the compressing the liquid phase material further comprises removing at least some of the plurality of gas bubbles from the liquid phase material that is located in the thin-wall section.

17. The method of claim 16, further comprising:
cooling the liquid phase material that is located in the second mold volume in order to convert the liquid phase material to a solid phase material and produce a part.

18. The method of claim 16, wherein the plurality of gas bubbles comprise an inert gas.

19. The method of claim 16, further comprising:
converting the material to the liquid phase.

20. The method of claim 19, further comprising:
introducing the gas bubbles into the liquid phase material.
